(19) United States
(12) Patent Application Publication
(10) Pub. No.: US 2015/0032481 A1
(43) Pub. Date: Jan. 29, 2015

(54) Method and Apparatus for Behavior Based Insurance

(71) Applicant: Farmers Group, Inc., Los Angeles, CA (US)

(72) Inventors: Stephen K. Norling-Christensen, Thousand Oaks, CA (US); Matthew J. Decelle, Thousand Oaks, CA (US); Kamalesh K. Jha, Los Angeles, CA (US); Thomas P. Richards, Los Angeles, CA (US); Brent E. Vollmer, Santa Clarita, CA (US)

(21) Appl. No.: 13/952,361

(22) Filed: Jul. 26, 2013

(51) Int. Cl. G06Q 40/08

(52) U.S. Cl. CPC G06Q 40/08
USPC 705/4

(57) ABSTRACT

Methods, financial systems, and devices of administering insurance policies with premiums based on user behavior monitored by a communication device are provided.

### FIELD OF INVENTION

The present invention relates generally to computer systems for use in the financial services field, and more particularly, but not by way of limitation, to computers for processing of data related to behavior-based insurance policies.

### BACKGROUND

In the field of insurance, various methods exist to establish the cost of insurance. Historically, insurance cost was based on data voluntarily supplied by the prospective insured in combination with data from publicly available sources such as actuarial data related to age and gender, driving records maintained by state bureaus of motor vehicles, credit histories, and the like. This data was then used to establish the cost of insurance through the use of a structure of actuarial classes, with varying insurance costs associated with each actuarial class. In addition, once an insurance premium was established, discounts have been applied as a result of satisfaction of desired behaviors, such as not smoking, in the case of life or health insurance, or accident free driving, use of seatbelts, and inclusion of vehicle equipment such as airbags and alarm systems in the case of automobile insurance. Much of this insurance pricing and discounting has been based on customer-supplied information which may be inaccurate, unreliable or, in some cases, fraudulent.

Recently, real-time recording devices such as personal communications devices (PCD's), like smart phones, have become widely adopted. Such devices include many sensors and are capable of providing extensive real-time data about the environment of the PCD, and, by implication, the environment and activities of a person possessing the PCD. However, to date, and despite the wide adoption of PCD's there has been no use of that available personalized data to price or discount insurance.

In the field of automobile insurance, there has been a move toward gathering more personalized data about the insured and the insured's vehicle through use of recording devices that monitor various characteristics of the driver and the vehicle, often in real time. Such characteristics may include, for example, speed, harsh acceleration and braking, duration of travel, time of day of travel, geographic location of travel, and the like. Such systems often use data provided by on-board computer systems that monitor and record the operating characteristics of the vehicle. Such data is accessible through an On-Board Diagnostic (OBD) interface that provides a standardized interface that is accessible through an electrical connector typically located under the dashboard in the passenger compartment of the vehicle. At present, insurance companies provide the insured with a customized recording device that plugs into the electrical OBD connector to record and communicate the vehicle's operating characteristics. Then, based on the data reported by the customized device, insurance companies price insurance and establish discounts.

However, these pre-existing systems require the use of a dedicated custom recording device that connects to the OBD system existing in the vehicle, and this custom device is in addition the other mobile electronic devices often carried by vehicle operators, such as cell phones, smart phones or other PCD's. Many such mobile devices have monitoring capabilities that are largely redundant to the characteristics monitored by standard OBD systems, such as acceleration, deceleration, geographic position, speed, time of day, and the like. Further, such mobile devices often have monitoring capabilities in addition to those provided by standard OBD system, such as telephone call behavior, texting behavior, and altitude. These additional parameters would also be useful in establishing the cost of vehicle insurance.

It would thus be desirable to be able to establish the cost of insurance based on real time measured parameters relating to the insured but without requiring dedicated custom hardware.

### SUMMARY

This disclosure includes embodiments of computer systems, computer-implemented methods, and computer-readable media for processing data related to an automobile insurance policy having premiums based on usage and other measurable parameters.

Wide adoption of PCDs in recent years has created opportunities to price risks more accurately compared to traditional methods. One feature of the present disclosure is the collection of different types of information through a PCD associated with the insured and using the data thus collected to predict the risk associated with the insured.

A PCD may provide access to a number of different sets of data elements which may be gathered from the device over a period of time which may then be used to deduce certain human behavior which may in turn be used to predict the risk associated with that behavior. This may be used to price multiple products offered by an insurance company, including, for example, vehicle insurance, home insurance, umbrella insurance, commercial insurance, specialty insurance and/or life insurance.

Examples of data that may be collected directly or derived from other data collected from PCD and that may be useful in pricing insurance, include, but are not limited to, location information, activity information, time, and information relating to social network activity including social network interaction between the insured and others.

More specifically, a PCD may take periodic readings of latitude and longitude through use of a GPS or other method such as triangulation using cellular information. This location information may then be used to detect a physical location throughout the day and may be used in association with available external databases to derive specific information related to the location, including, for example whether the location is urban or rural, whether the location is residential or commercial; or whether the location is within a building or outside, and so forth

Activities of an insured may be derived through use of various sensors available on the PCD such as, for example GPS, detectors and accelerometers, and this data may be combined with the locational information and movement patterns associated with different activities to deduce an activity of the insured, for example, walking, running, bicycling, driving or boating. A PCD may also be used to keep records of the activities a user is engaged in through the device itself, including, for example, texting, calling, internet browsing, watching shows, playing games, and the like. A PCD may also record time of day (morning, afternoon, night) as well as derive the time period associated with a particular activity.

Yet further, social circles and use of social networks/media may be derived through use of the PCD by recording online activity engaged in by the insured via social networks, such as, for example, Facebook, Twitter, Instagram, and others. These activities may provide demographic information regarding the insured, and also provide information about other online activity, for example, the use of likes and dislikes of certain kinds of products or services.

Various interactions between these sets of data elements collected through PCD may then be used to derive predictive models for pricing of insurance products, such as, for example, life insurance, vehicle insurance, home insurance, umbrella insurance, commercial insurance and specialty insurance.

According to one aspect of the present disclosure, a computer system is provided for processing data related to an insurance policy, the computer system including a personal communication device for sensing and recording data related to selected characteristics indicative of an individual's behavior; and a processor in communication with the personal communication device. The processor is configured to communicate with the personal communication device to download said data related to selected characteristics, for each characteristic, to determine: an appropriate actuarial class selected from at least one predetermined actuarial class, to determine a composite insurance score from the actuarial classes, and to apply an insurance premium discount or surcharge based on the composite insurance score. The insurance policy may be a life insurance policy, a homeowners insurance policy, a vehicle insurance policy, an umbrella insurance policy, a commercial insurance policy or a specialty insurance policy.

In accordance with another aspect of the present disclosure, the processor of the computer system may further function to determine at least one environmental characteristic based on the data related to the selected characteristics, to determine an environmental actuarial class for the environmental characteristic, and to determine the composite insurance score from the environmental actuarial class.

In accordance with yet another aspect of the present disclosure, a computer system may be provided for processing data related to a vehicle insurance policy. The computer system may include a personal communication device for sensing and recording data related to selected characteristics indicative of driver behavior, including geographic position, time of day, acceleration, deceleration, telephone call occurrence and duration, and texting occurrence. The computer system may further include a processor in communication with the personal communication device the processor configured to communicate with the personal communication device to download said data related to selected characteristics, for each characteristic, to determine an appropriate actuarial class selected from at least one predetermined actuarial class, to determine a composite driving score from the at least one actuarial class, to provide an output signal indicative of the composite driving score, and to provide a cost of an insurance policy based on the composite driving score. The computer system may be further configured to provide a report to the driver, and to apply an insurance premium discount or surcharge based on the composite driving score.

These and other features and aspects of the present disclosure will become apparent from the following more detailed description.

### BRIEF DESCRIPTION OF DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram of an example of a system for implementation of embodiments of the present methods and systems.

FIG. 2 is a block diagram of an example of a computer hardware network environment with networked devices for implementation of embodiments of the present methods and systems.

FIG. 3 is a flowchart of an embodiment of the process flow of the present disclosure to determine a driving score.

FIGS. 4 and 5 are examples of screen shots produced by a PCD in accordance with certain aspects of the invention

FIGS. 6-9 are examples of screen shots produced by a web-based server in accordance with certain aspects of the present disclosure.

### DETAILED DESCRIPTION

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified, as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a system, element of a system, software module, or the like that is configured in a certain way is configured in at least that way, but it can also be configured in other ways than those specifically described.

The figures and descriptions have been simplified to illustrate elements that are relevant for a clear understanding of the present embodiments, while eliminating, for the purpose of clarity, many other elements found in typical computer systems and methods for processing of data relating to insurance. Those of ordinary skill in the art may recognize that other well-known elements and/or steps are desirable and/or required in implementing the present embodiments.

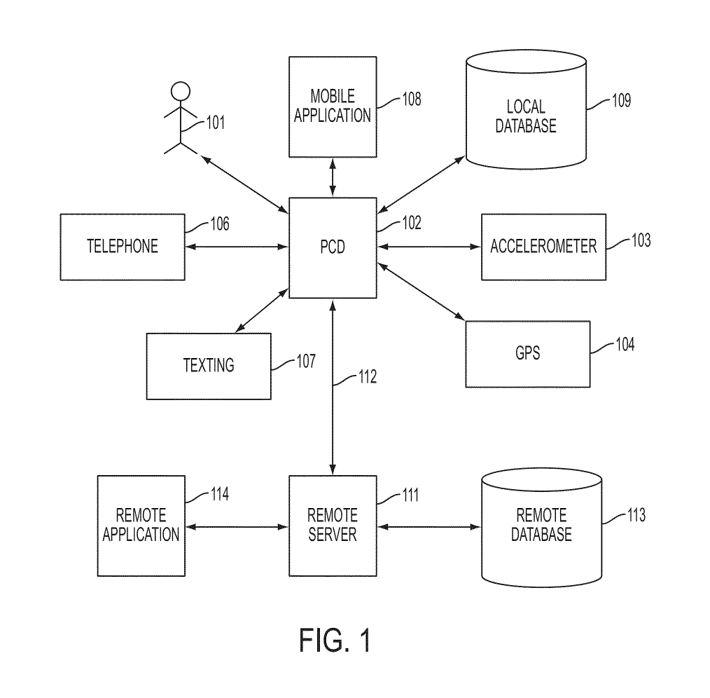

FIG. 1 is a block diagram of a behavior-based insurance system in accordance with certain aspects of the present disclosure. Shown is a system for monitoring user 101 that sends information from a user's personal communication device, PCD 102, which may be, for example, a smart phone available from various companies, including Apple, Google Research in Motion, Samsung, HTC, Nokia and others, or any other personal communication device that has appropriate monitoring and communication capabilities along with the ability to download and execute applications. PCD 102 typically includes sensing functions provided by internal sensors such as accelerometer 103 and global positioning system (GPS) 104, and also typically includes telephone functions 106 and texting functions 107, all of which may be used to produce data indicative of user behavior.

PCD 102 also includes a user-based insurance application 108 that may be downloaded from a remote site, and that controls PCD 102 to organize the data indicative of user behavior for storage in local database 109, to display that data in a form useable by the user, and to communicate with remote server 111 through communication link 112. Communication link 112 may be any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Once a connection between PCD 102 and remote server 111 is established, PCD 102 may store data related to user behavior on a remote database 113 or similar data repository. Database 113 may then be used in association with a remote application 114 for the purpose of conditioning the data for display and/or use to determine behavior based insurance premiums and/or discounts as explained in more detail below.

One objective of the present disclosure is to provide a user based insurance product that collects data related to user behavior through use of a mobile application resident on a PCD. The data provided by dedicated data recording devices, such as standard OBD data buses in the case of vehicle insurance, is not used, and all measured data is provided by the PCD. User behavior collected during a policy period may then be used to classify a user into actuarial classes for the purpose of pricing various insurance products.

Data recording by the PCD may be started at the beginning of an activity and stopped at the end of the activity, or data recording may be substantially continuous without a start and stop event, or recording may be in random intervals that are started and stopped at substantially random times. This permits the interaction of various recorded activity data and permits a more accurate rating based on the behavior of a user that predicts risk level. The monitoring application runs in the background in order to permit the PCD to perform its other intended functions without interruption. The data recorded for each activity may be reviewable in various forms such as graphically, pictorially and/or in the form of a map.

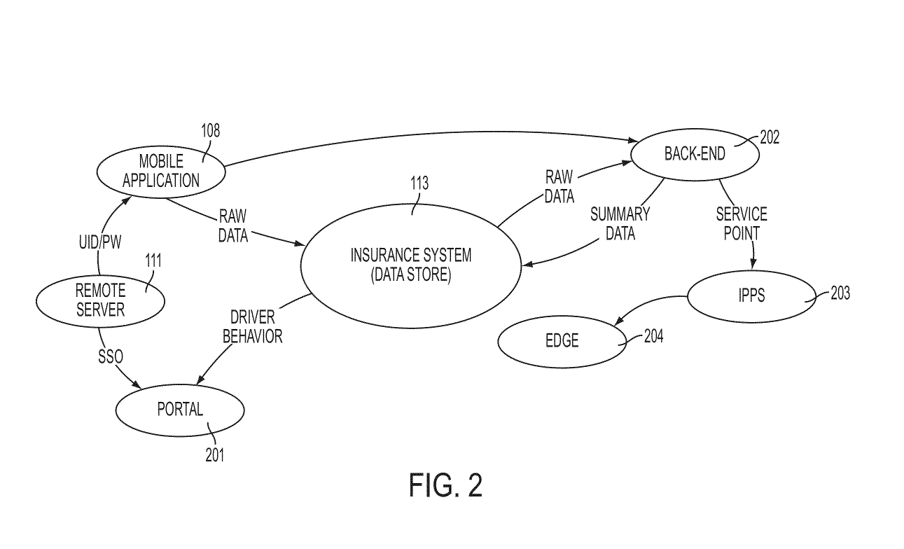

FIG. 2 is a block diagram of an example of a data network that may be used to practice methods of the present disclosure. Mobile Behavior application 108 interfaces with remote server 111 and remote database 113 as described above. In addition, portal 201 permits a user to review behavior information and to manage social interactions with friends and family through a social network, or the like. Backend server 202 stores user behavior data and processes the data to produce a user score and provides information to portal 201. Insurance Policy Processing System (IPPS) 203 is used to process insurance policies and captures policy record information, stores the information, performs insurance rating functions, performs insurance underwriting functions, and interfaces with accounting systems (not shown). IPPS 203 will also validate and apply any applicable behavior discount. EDGE (Enterprise Document Generation Enterprise) 204 generates documents to send to the customer including any required declarations and contracts. For behavior based insurance, EDGE 204 generates and causes to be sent a declaration page to the customer listing any behavior discounts when a discount is applied by IPPS 203.

In some embodiments, functions are achieved using one or more modules of a computer software program in combination with one or more components of hardware. Such software programs will be used generally where a policy owner, insured, broker or advisor or other representative of an insured or owner has sent a request for data or information to a server and comprises part of the processing done on the server side of the network. The program may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or insurance processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as smart phone 294, and capable of being accessed and executed by a processor of the client device.

As used herein, a module of executable code may, for instance, comprise one or more physical or logical blocks of computer instructions that may, for instance, be organized as an object, procedure, process, or function. Nevertheless, the executable of an identified module need not be physically located together, but may comprise separate instructions stored in different locations that, when joined logically together, comprise the module and achieve the stated purpose for the module such as implementing the business rules logic described herein. A module of executable code may be a compilation of many instructions, and may even be distributed over several different code partitions or segments, among different programs, and across several devices. Similarly, data, including by way of example policy data, insured data, and investment data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

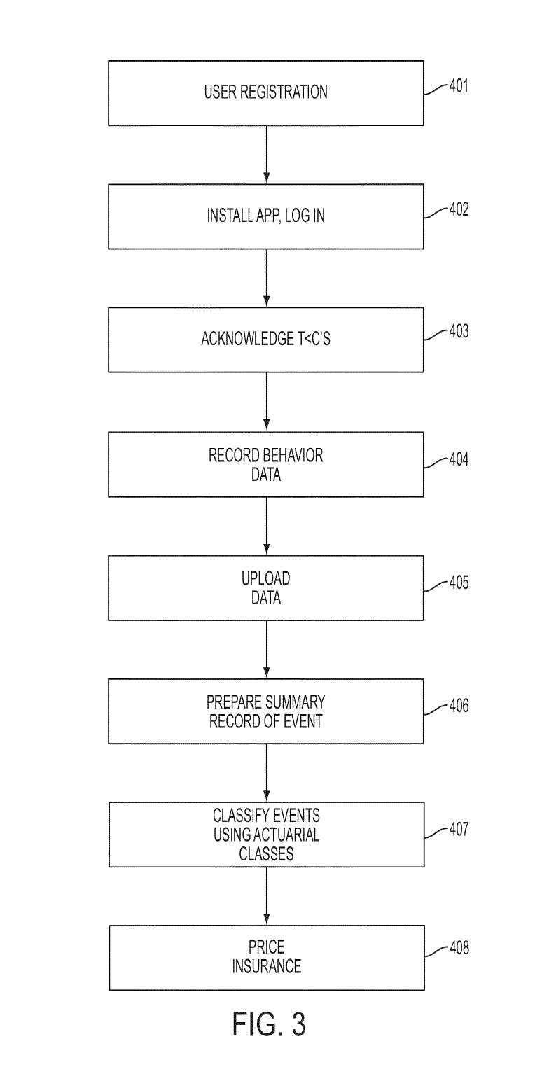

FIG. 3 is a flowchart of the process overview of the behavior based insurance product of the present disclosure. In FIG. 3, steps 401-403 represent the registration process, and steps 404-407 represent the monitoring and calculation processes. Beginning in step 401, a user of the system registers with the main server using a user identification number and password if already a customer, or through the web portal (201, FIG. 2) if not yet a registered customer. Next in step 402, the user downloads a mobile application to his or her PCD using any of several acceptable methods such as an on-line application store or the like. In step 403, after a user acknowledges the terms of use, if any, the mobile application begins running on the PCD in the background.

Turning now to step 404, behavior date is recorded. This may happen once an activity has started, the mobile application resident on the PCD is triggered to begin collecting data. Such a start trigger event may take several forms including the detection of movement by the PCD using internal accelerometers and/or GPS detectors. In the alternative, a start trigger event may be supplied manually by the user. Then, data recording continues until a stop trigger event occurs. Similar to a start trigger event, a stop trigger event may be automatic through motion detection by the PCD or may be initiated manually by the user. In another alternative embodiment, behavior data may be recorded substantially continuously whenever the mobile application is running. In a further alternative embodiment, behavior data may be recorded in intervals of random length with each interval having random start and stop times in order to provide a substantially random sampling of behavior data. Next, in step 405, recorded data is uploaded to the central system using communication link 112 (FIG. 1) using one of the various acceptable methods mentioned above. Then, in step 406, the central server may prepare a summary of the recorded data records for each activity, including, for example, walking, driving, hiking, bicycling, the number of speeding occurrence, harsh braking occurrences, sudden acceleration occurrences, and the occurrences of text messaging and/or phone calls. The summaries may be presented to the user in many forms. Finally, in step 407, the central server conditions the recorded data to classify the user into actuarial classes for each policy period, which in turn may be used in step 408 to set insurance premiums and/or to calculate discounts, refunds or surcharges.

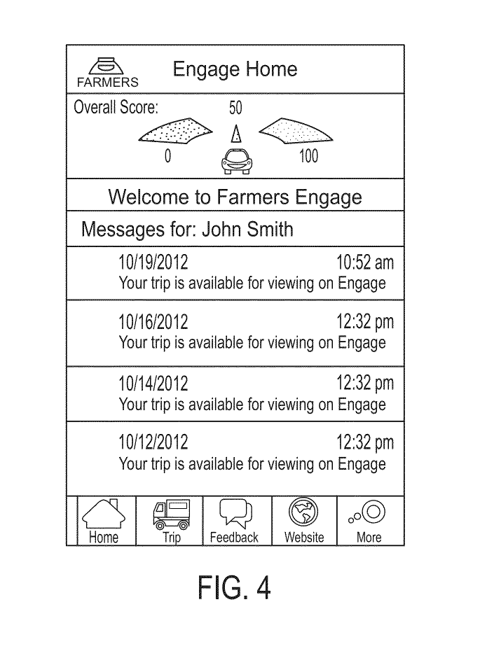

Referring now to FIG. 4, shown is an example of a screen shot produced by PCD 102 to display a plurality of trips that have been recorded when the recorded behavior deals with driving a vehicle. A user may select a particular trip for a more detailed display of trip data, including a map of the trip, a driving score for the trip, and other information. In addition, the overall driving score for all trips may be displayed.

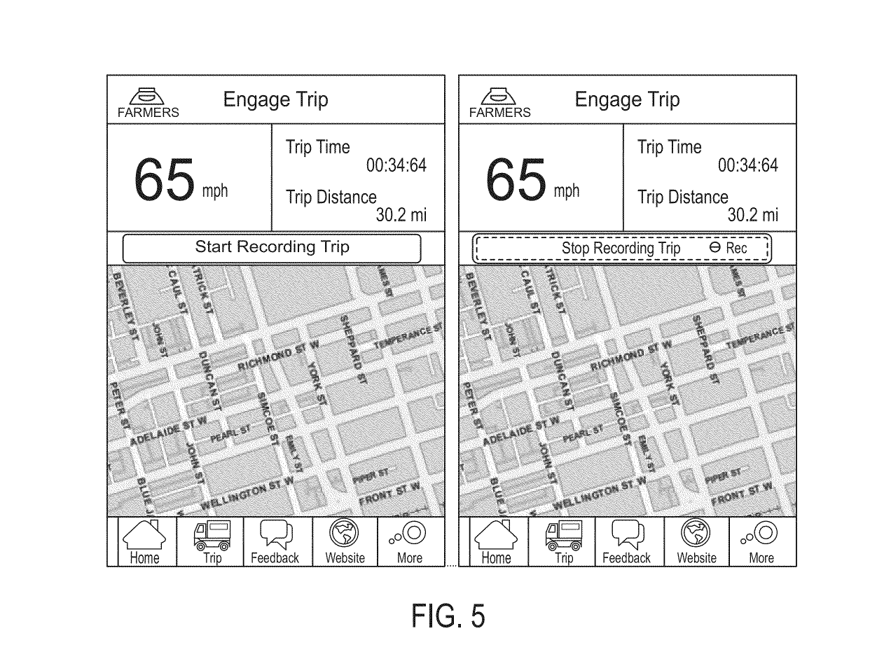

FIG. 5 shows other examples of screen shots produced by PCD 102, this time of a map display of a recorded trip, along with other data including average speed and elapsed time.

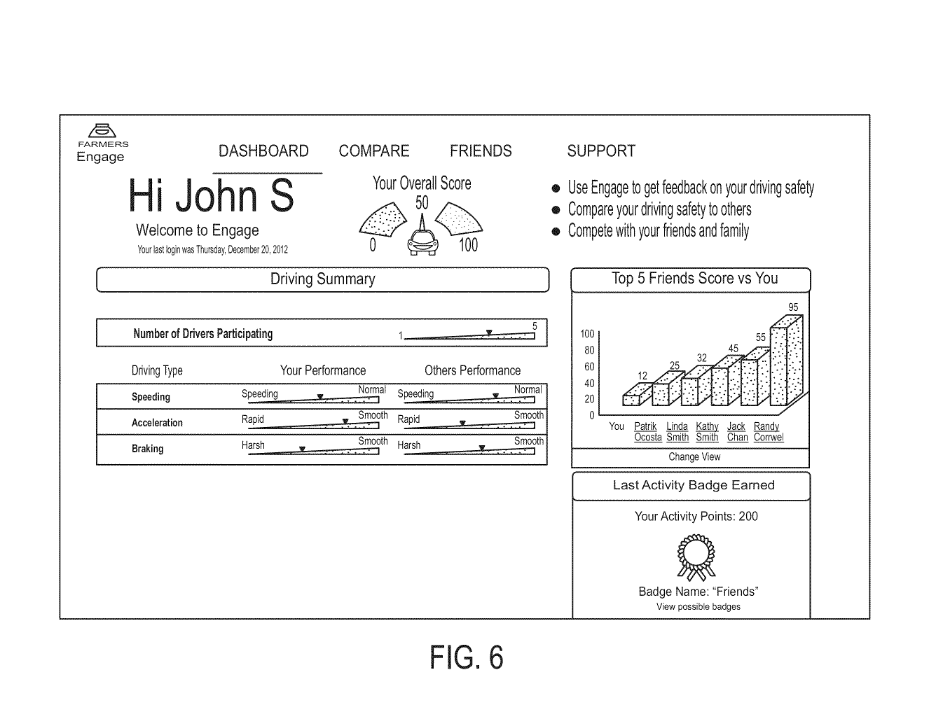

FIGS. 6-9 are examples of screens produced by remote server 111 in accordance with aspects of the present disclosure. These screens may be displayed on a computing device such as a personal computer, lap top, or a PCD that is connected to the remote server 111 over the internet or other communication network.

FIG. 6 is a dashboard view of data for a typical driver using the system of the present disclosure when the recorded behavior deal with driving a vehicle. Information may be graphically displayed to show overall driving score for the user along with numerical scores for selected driving characteristics such as speeding, acceleration and braking. In addition, a comparison with other drivers may be provided. The other drivers may be selected by the user from among other users of the system through use of social network applications and the like.

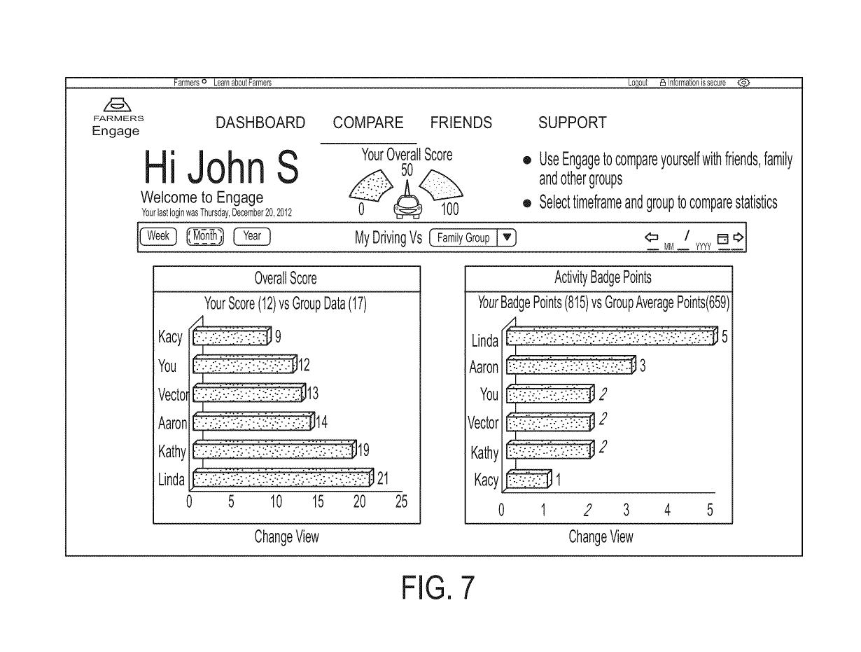

FIG. 7 provides another screen produced by remote server 111 that presents another form of display and comparison with other drivers, this time in the form of a bar graph of overall driving scores, and also a comparison of awards (badges) that may be given as an incentive to promote good driving behavior.

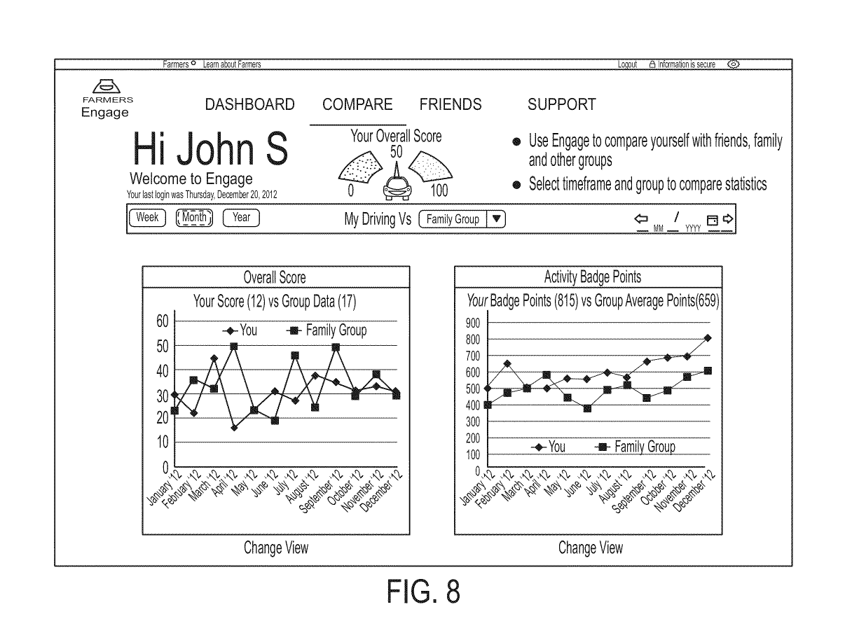

FIG. 8 presents another screen produced by remote server 111 of data similar to that shown in FIG. 7, but in graph form.

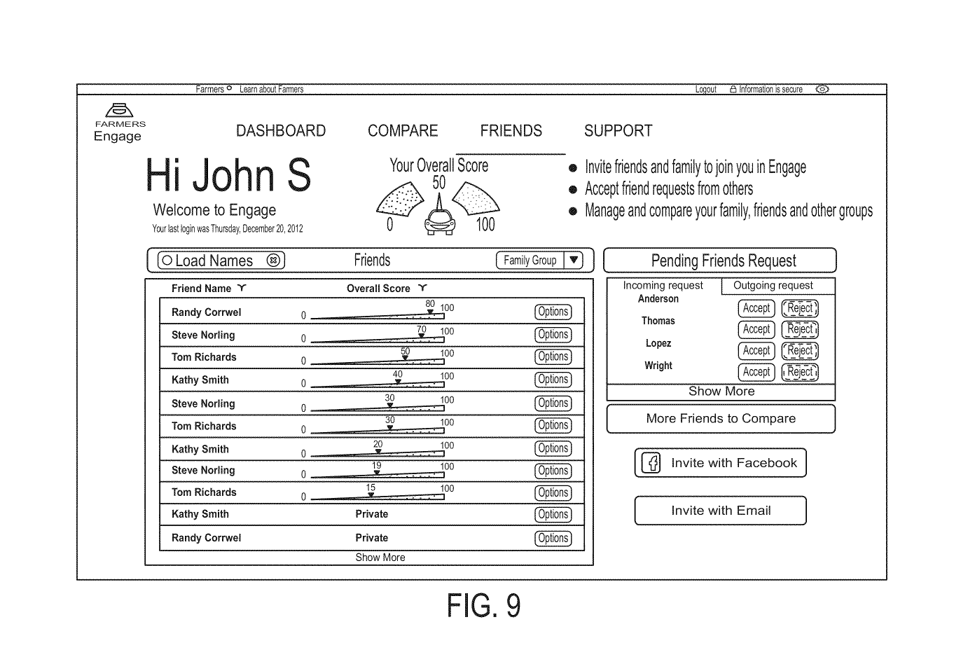

Finally FIG. 9 shows a screen produced by remote server 111 showing a “friends” list created by a user in order to allow comparison of driving and other behaviors and scores among a group of people. The list may be created in a known manner through use of requests submitted through a social network, such as Facebook, Twitter, Instagram, or the like.

PCD 102 may also provide access to a number of different sets of data elements which may be gathered from PCD 102 over a period of time which may then be used to deduce certain human behavior which may in turn be used to predict the risk associated with that behavior. This may be used to price multiple products offered by an insurance company, including, for example, vehicle insurance, home insurance, umbrella insurance, commercial insurance, specialty insurance and/or life insurance.

Examples of data that may be collected directly or derived from other data collected from PCD 102 and that may be useful in pricing insurance, include, but are not limited to, location information, activity information, time, and information relating to the use of various social networks, including, for example, Facebook, Twitter and Instagram.

More specifically, PCD 102 may take periodic readings of latitude and longitude through use of a GPS or other method such as triangulation using cellular information. This location information may then be used to detect a physical location throughout the day and may be used in association with available external databases to derive specific information related to the location, including, for example whether the location is urban or rural, whether the location is residential or commercial; or whether the location is within a building or outside, and so forth

Activities of an insured may be derived through use of various sensors available on PCD 102 such as, for example GPS, detectors and accelerometers, and this data may be combined with the locational information and movement patterns associated with different activities to deduce an activity of the insured, for example, walking, running, bicycling, driving or boating. PCD 102 may also be used to keep records of the activities a user is engaged in through the device itself, including, for example, texting, calling, internet browsing, watching shows, playing games, and the like.

Further, PCD 102 may record time of day (morning, afternoon, night) as well as derive the time period associated with a particular activity.

Various interactions between these sets of data elements collected through PCD 102 may then be used to derive predictive models for pricing of insurance products, such as, for example, life insurance, vehicle insurance, home insurance, umbrella insurance, commercial insurance and specialty insurance.

For Example, someone who is frequently outdoors (location), engages in running (activity) for 30 minutes (time period) every day, will be a different kind of risk for insuring Life than someone who stays indoors all day and is engaged in game playing for more than an hour every day. Presented below are examples to price life insurance, home owners insurance and vehicle insurance using these categories. Similar techniques can be applied to price for umbrella, commercial, specialty and other types of insurance.

### Behavior Based Insurance Calculation Example:

Presented below is an example of calculation for behavior-based life and home owners insurance in accordance with aspects of the present disclosure. The various factors used in the calculations are based on parameters measured by PCD 102 (FIG. 1) and by use of predetermined actuarial tables such as those tables shown for example in the Appendix hereto. Specifically, the factors used to calculate the Behavior Score below are shown in Tables 15 and 16, and 13. It should be noted that different factors based on different parameters measured by PCD 102 may also be used without departing from the scope of the disclosure.

Step 1: Behavior Score Calculation

Behavior Score=100×((Location,Activity,Time Paeriod Factor,Table 15)×(Social Circle Factor,Table 16)

Step 2: Life/Home Owners Insurance Discount Factors

Determine the Life/Home Owners Insurance Discount Factors for each user by using the life insurance discount factor and the homeowners insurance discount factor corresponding to the behavior score as shown for example in Table 13.

Based on the life/home owners insurance discount factors shown in Table 13, appropriate insurance premiums may be determined by, for example, determining a base premium and applying a discount or penalty based on behavior based score. It should be noted that other types of insurance may also be priced using the present disclosure, including, for example, vehicle, umbrella, commercial and specialty insurance.

Presented below is specific example using behavior to price vehicle insurance, also referred to as usage based insurance (UBI)

### Usage Based Insurance Calculation Example:

One type of behavior based insurance is usage-based vehicle insurance. Presented below is an example of calculation for usage-based vehicle insurance in accordance with aspects of the present disclosure. The various factors used in the calculations are based on parameters measured by PCD 102 (FIG. 1) and by use of predetermined actuarial tables such as those tables shown for example in the Appendix hereto. Specifically, the factors used to calculate the Driving Score below are shown in Tables 1-11, and the Discount Adjustment Factor is shown for example in Table 12. It should be noted that different factors based on different parameters measured by PCD 102 may also be used without departing from the scope of the disclosure

Step 1: Driving Score Calculation

Driving Score=100×((Last 60 Day Mileage Factor,Table 1)×(Total # of Speeding Occurrences per 100 Miles Driven Factor,Table 2)×(Total # of High Acceleration Occurrences per 100 miles driven Factor,Table 3)×(Total # of Harsh Braking Occurrences per 100 miles driven Factor,Table 4)×(% of Miles Driven between 11 pm 5 am Factor,Table 5)×(% of Miles Driven between 8 pm-11 pm Factor,Table 6)×(% of Miles Driven between 6 am-9:30 am+4:30 pm−6:30 pm Factor,Table 7)×(Total # of Texts Sent per 100 miles driven Factor,Table 8)×(Total # of Calls Placed per 100 miles driven Factor,Table 9)×(% of Time on Phone per 1 Hour Driven Factor,Table 10))

Step 2: Determine Driving Score Factor

Determine the Driving Score Factor for each driver by using the driving score corresponding to the driving score factor as shown for example in Table 11.

Step 3: Determine Discount Adjustment Factor

Determine the Discount Adjustment Factor for each driver using the number of trips and mileage for last 60 days as shown for example in Table 12.

Step 4: Calculate Final Driver UBI Factor

Calculate the Final UBI factor for each driver. Final UBI Factor=1−(Driving Score Discount (step 2)*Discount Adjustment Factor (step 3))

Step 5: Calculate Policy Level UBI Factor

Calculate the Policy Level UBI Factor. Policy Level UBI Factor=(1−(Final UBI Factor (Step 4) for each driver in the household÷total number of drivers in the household). Drivers on the policy that do not participate in UBI will use a Final UBI Factor=1.0. Excluded drivers will not be considered in calculation.

The calculations described above are presented herein for illustrative purposes only, the methods disclosed herein may be used with a variety of calculation methodologies for calculating specific values. In an embodiment, the calculations described above are performed on a computer system, an embodiment of such a computer system is described above.

When pricing insurance products other than vehicle, various other types of scores may be derived from the information collected through the PCD 102 (FIG. 1) using the factors used above to calculate a Driving Score, either alone, or in combination with other data derived from PCD 102, and this data may be used to calculate a score or scores that are predictive of the risk associated with the customer. This use of this extensive behavior data may also be used to link to additional sources of information including weather information, traffic congestion information, and the like, to provide even more demographic information usable in assessing risk. This score or scores may then be used to price other insurance policies besides vehicle insurance such as, for example, life insurance or homeowners insurance.

In addition, external factors may be used to derive the insurance scores. For example, using the activity information collected by PCD 102, such as, for example, the activity location and day/time of the activity, environmental contextual information may be derived from other resources and that information may be used to calculate an environmental factor. This additional set of information may include, for example, weather conditions and road conditions for a trip. One example of the algorithm to calculate the environmental factor is shown below with reference to driving behavior.

Based on the combination of road and weather conditions recorded by or derived from data recorded by PCD 102 during a trip or trips, a correction factor may be derived for each trip, as shown for example in Table 14 in the Appendix.

Referring to Table 14, assignment of a trip to road condition and weather condition categories may depend on variables, such as, for example, traffic congestion at the time of the trip as well as road curvature, junctions, road controls, and/or the rural vs urban setting of the road traveled during the trip. For example, category A may mean optimal road or weather conditions for driving (no rain or snow, no traffic congestion, and the like) while category C may mean adverse conditions (snow, traffic congestion, road with frequent curves, and the like).

The factors for individual trips may be used to derive the final environmental factor for the driver based on the trips taken in last 60 days, for example. For example the Final Environmental Factor may be calculated as a weighted average of the miles of each trip and the environmental factor for each trip. The Final environmental factor may then be used to adjust the driving score derived in step 1 above. Final Driving Score=Driving Score from step 1×(1+Final Environmental Factor)

The above specification and examples provide a description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

### APPENDIX

This Appendix includes examples of predetermined actuarial tables that are used to determine the various factors used in calculating a behavior score, including driving score, in accordance with the disclosure. It will be appreciated that these factors are offered as examples only and should not be considered to limit the disclosure to the particular factors presented. In addition, some of these factors may be eliminated without departing from the spirit and scope of the disclosure.

TABLE 1
Total Number of Speeding Occurrences
Per 100 Miles Driven Factor Example

| Min | Max | Factor |
|---|---|---|
| 0.000 | 1.5 | 0.7 |
| 1.5 | 3.5 | 0.8 |
| 3.5 | 6.5 | 0.9 |
| 6.5 | 12.5 | 1.0 |
| 12.5 | 24 | 1.1 |
| 24 | 40 | 1.2 |
| 40 | + | 1.3 |

TABLE 2
Last 60 Day Mileage Factor Example

| Min | Max | Factor |
|---|---|---|
| 0.000 | 0.000 | 0.75 |
| >0 | 80 | 0.8 |
| 80 | 250 | 0.9 |
| 250 | 450 | 1.0 |
| 450- | 850 | 1.1 |
| 850 | 1600 | 1.2 |
| 1600 | 2500 | 1.3 |
| 2500 | + | 1.4 |

TABLE 3
Number of High Accelerations Per
100 Miles Driven Factor Example

| Min | Max | Factor |
|---|---|---|
| 0.000 | 0..5 | 0.5 |
| 0.5 | 1.0 | 0.6 |
| 1.0 | 1.5 | 0.7 |
| 1.5 | 2.5 | 0.8 |
| 2.5 | 4 | 0.9 |
| 4 | 6 | 1.0 |
| 6 | 8 | 1.1 |
| 8 | 10 | 1.2 |
| 10 | 12 | 1.3 |
| 12 | 20 | 1.4 |
| 20 | + | 1.5 |

TABLE 4
Harsh Braking Occurrences Per 100 Miles Driven Facto Example

| Min | Max | Factor |
|---|---|---|
| 0.000 | 0.5 | 0.5 |
| .5 | 1 | 0.6 |
| 1 | 2 | 0.7 |
| 2 | 4 | 0.8 |
| 4 | 6 | 0.9 |
| 6 | 9 | 1.0 |
| 9 | 12 | 1.1 |
| 12 | 16 | 1.3 |
| 16 | 20 | 1.4 |
| 20 | + | 1.5 |

TABLE 5
Percentage of Miles Driven 11 PM-5 AM Factor Example

| % of Miles | Factor |
|---|---|
| 0 | 0.5 |
| 0-10 | 0.7 |
| 10-30 | 0.9 |
| 30-50 | 1.1 |
| 50-70 | 1.2 |
| 70-90 | 1.3 |
| 90-100 | 1.4 |

TABLE 6
Percentage of Miles Driven 8 PM-11 PM Factor Example

| % of Miles | Factor |
|---|---|
| 0-20 | 0.9 |
| 20-40 | 0.95 |
| 40-60 | 1.0 |
| 60-80 | 1.05 |
| 80-100 | 1.1 |

TABLE 7
Percentage of Miles Driven between 6 AM-
9:30 AM + 4:30 PM-6:30 PM Factor Example

| % of Miles | Factor |
|---|---|
| 0-20 | 0.75 |
| 20-40 | 0..9 |
| 40-60 | 1.0 |
| 60-80 | 1.1 |
| 80-100 | 1.2 |

TABLE 8
Number of Texts Sent per 100 Miles Factor Example

| Min | Max | Factor |
|---|---|---|
| >0 | 1 | 0.9 |
| 1 | + | 1.0 |

TABLE 9
Number of Calls Placed Per 100 Miles Factor Example

| Min | Max | Factor |
|---|---|---|
| >0 | 5 | 0.8 |
| 5 | 10 | 0.9 |
| 10 | + | 1.00 |

TABLE 10
Percentage of Time on Phone per 1 Hour Driven Factor Example

| % of Time | Max | Factor |
|---|---|---|
| >0 | 30 | 0.8 |
| 30 | 60 | 0.9 |
| 60 | 100 | 1.00 |

TABLE 11
Driving Score Factor Example

| Driving | BI | PD | MED | PIP | COMP | COLL | UM | UMPD |
|---|---|---|---|---|---|---|---|---|
| Score | Factor | Factor | Factor | Factor | Factor | Factor | Factor | Factor |
| 0-8 | .15 | .15 | .15 | .15 | .15 | .15 | .15 | .15 |
| 9-10 | .14 | .14 | .14 | .14 | .14 | .14 | .14 | .14 |
| 11-12 | .13 | .13 | .13 | .13 | .13 | .13 | .13 | .13 |
| 13-16 | .12 | .12 | .12 | .12 | .12 | .12 | .12 | .12 |
| 17-23 | .11 | .11 | .11 | .11 | .11 | .11 | .11 | .11 |
| 24-33 | .10 | .10 | .10 | .10 | .10 | .10 | .10 | .10 |
| 34-63 | .09 | .09 | .09 | .09 | .09 | .09 | .09 | .09 |
| 64-86 | .08 | .08 | .08 | .08 | .08 | .08 | .08 | .08 |
| 87-107 | .07 | .07 | .07 | .07 | .07 | .07 | .07 | .07 |
| 108-130 | .06 | .06 | .06 | .06 | .06 | .06 | .06 | .06 |
| 131+ | .05 | .05 | .05 | .05 | .05 | .05 | .05 | .05 |

Legend for Table 11:
BI: Bodily Injury Coverage
PD: Property Damage Coverage
UM: Uninsured Motorist Coverage
UMPD: Uninsured Motorist Property Damage Coverage
MED: Medical Coverage
PIP: Personal Injury Protection Coverage
COMP: Comprehensive Coverage
COLL: Collision Coverage

TABLE 12
Discount Adjustment Factor Example

| | | Discount |
|---|---|---|
| # of Trips Per Month | Last 60 Day Mileage | Adjustment Factor |
| 1-6 | 0-100 | 0.00 |
| 7+ | 0-100 | 0.25 |
| 1-4 | 200 | 0.00 |
| 5-6 | 200 | 0.25 |
| 7-15 | 200 | 0.50 |
| 15+ | 200 | 0.75 |
| 1-4 | 300 | 0.00 |
| 5-10 | 300 | 0.25 |
| 11-20 | 300 | 0.75 |
| 21+ | 300 | 1.00 |
| 1-4 | 400 | 0.00 |
| 5-6 | 400 | 0.25 |
| 7-10 | 400 | 0.50 |
| 11-15 | 400 | 0.75 |
| 15+ | 400 | 1.00 |
| 1-4 | 500 | 0.00 |
| 5-6 | 500 | 0.25 |
| 7-10 | 500 | 0.50 |
| 11-15 | 500 | 0.75 |
| 15-16 | 500 | 1.00 |
| 17+ | 500 | 1.00 |
| 1-4 | 600+ | 0.00 |
| 5-6 | 600+ | 0.25 |
| 7-10 | 600+ | 0.50 |
| 11-15 | 600+ | 0.75 |
| 16+ | 600+ | 1.00 |

TABLE 13
Life/Homeowners Insurance Discount Factor Example

| Behavior | Life Insurance | Homeowners Insurance |
|---|---|---|
| Score | Discount Factor | Discount Factor |
| 0-10 | .15 | .15 |
| 11-20 | .14 | .14 |
| 21-35 | .13 | .13 |
| 36-50 | .12 | .12 |
| 51-65 | .11 | .11 |
| 66-70 | .10 | .10 |
| 71-90 | .09 | .09 |
| 91-110 | .08 | .08 |
| 111-130 | .07 | .07 |
| 131-150 | .06 | .06 |
| 150+ | .05 | .05 |

TABLE 14
Trip Environmental Factor Example

| Road Condition | Weather Conditions | Trip Environmental Factor |
|---|---|---|
| A | A | 0.01 |
| A | B | 0.02 |
| A | C | 0.03 |
| B | A | 0.02 |
| B | B | 0.04 |
| B | C | 0.06 |
| C | A | 0.03 |
| C | B | 0.06 |
| C | C | 0.09 |

TABLE 15
Location, Activity and Time Period Factor Example

| | | | Location, Activity, |
|---|---|---|---|
| Location | Activity | Time Period | Time Factor |
| Outdoor | Running | <30 | 0.95 |
| Outdoor | Running | 30-60 | 0.90 |
| Outdoor | Running | >60 | 0.85 |
| Outdoor | Biking | <30 | 0.93 |
| Outdoor | Biking | 30-60 | 0.88 |
| Outdoor | Biking | >60 | 0.83 |
| Indoor | Game Playing | <30 | 1.00 |
| Indoor | Game Playing | 30-60 | 1.05 |
| Indoor | Game Playing | >60 | 1.10 |

TABLE 16
Social Circle Factor Example

| Social Circle | Social Circle Factor |
|---|---|
| Heli Skiing Enthusiasts | 1.15 |
| Big Wave Surfers | 1.10 |
| Motorcyclists | 1.05 |

1. A computer system for processing data related to an insurance policy, comprising:
a personal communication device for sensing and recording data related to selected characteristics indicative of an individual's behavior; and
a processor in communication with the personal communication device the processor configured to:
communicate with the personal communication device to download said data related to selected characteristics,
for each characteristic, determine an appropriate actuarial class selected from at least one predetermined actuarial class,
determine a composite insurance score as a function of the at least one actuarial class, and
apply an insurance rating factor based on the composite insurance score to determine an insurance premium.

2. The computer system of claim 1, the insurance policy comprising a life insurance policy.

3. The computer system of claim 1, the insurance policy comprising a homeowners insurance policy.

4. The computer system of claim 1, the insurance policy comprising a vehicle insurance policy.

5. The computer system of claim 1, the insurance policy comprising a specialty insurance policy.

6. The computer system of claim 1, the insurance policy comprising a commercial insurance policy.

7. The computer system of claim 1, the processor further configured to:
determine at least one environmental characteristic based on the data related to the selected characteristics;
determine an environmental actuarial class for the environmental characteristic; and
determine the composite insurance score also as a function of the environmental actuarial class.

8. A computer system for processing data related to a vehicle insurance policy, comprising:
a personal communication device for sensing and recording data related to selected characteristics indicative of driver behavior, including geographic position, time of day, acceleration, deceleration, telephone call occurrence, and texting occurrence; and
a processor in communication with the personal communication device the processor configured to:
communicate with the personal communication device to download said data related to selected characteristics,
for each characteristic, determine; an appropriate actuarial class selected from at least one predetermined actuarial class,
determine a composite driving score from the at least one actuarial class, and
apply an insurance rating factor based on the composite driving score to determine an insurance premium for a vehicle insurance policy.

9. The computer system of claim 8, the processor further configured to,
provide a report to the driver.

10. A computer-implemented method for processing data related to an automobile insurance policy, comprising:
monitoring one or more driving characteristics of a vehicle using a personal communication device physically located within the vehicle;
accessing the personal communications device by a processor;
using a set of predetermined actuarial classes to select, by the processor, one or more actuarial classes corresponding to monitored values of said driving characteristics;
determining by the processor a driving score based upon the respective selected actuarial classes; and
determining, by the processor, a premium for an automobile insurance policy based on the driving score.

11. The computer-implemented method of claim 11, driving characteristics including, harsh braking, harsh acceleration, speed, telephone call occurrences and texting occurrences.

12. The computer implemented method of claim 12, further comprising:
determining by the processor an environmental characteristic based upon the monitored values of said driving characteristics;
determining by the processor an actuarial class corresponding to the environmental characteristic; and
determining by the processor the driving score based upon the environmental actuarial class.

13. A non-transitory computer-readable medium, the computer-readable medium having processor-executable instructions stored thereon, which instructions, when executed by the processor, cause the processor to:
monitor at least one behavior characteristic of a user using a personal communication device physically located with the user;
access the personal communications device by a processor;
use a set of predetermined actuarial classes to select, by the processor, one or more actuarial classes corresponding to monitored values of said at least one behavior characteristic;
determine, by the processor, a behavior score based upon the selected actuarial classes; and
apply an insurance rating factor based on the behavior score to determine an insurance premium for an insurance policy.
